(19) United States
(12) Patent Application Publication
(10) Pub. No.: US 2005/0137316 A1
(43) Pub. Date: Jun. 23, 2005

(54) Tire with component comprised of an immiscible blend of polybutadiene rubber and brominated copolymer of isobutylene and para methylstyrene

(76) Inventor: David John Zanzing, Bertrange (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/989,627

(22) Filed: Nov. 16, 2004

Related U.S. Application Data
(60) Provisional application No. 60/531,083, filed on Dec. 19, 2003.

(51) Int. Cl. C08K 3/34; C08K 3/04

(52) U.S. Cl. 524/492; 524/495

(57) ABSTRACT

Pneumatic rubber tire having at least one component of a polybutadiene-rich rubber composition comprised of a blend of a primary, low glass transition temperature (Tg), major continuous phase of cis 1,4-polybutadiene rubber having a degree of branching and a minor, high Tg, dispersed phase of brominated copolymer of isobutylene and paramethylstyrene. Said blend contains reinforcing fillers as a combination of amorphous silica and rubber reinforcing carbon black. Such tire component may be, for example, a circumferential tread having a running surface intended to be ground-contacting.

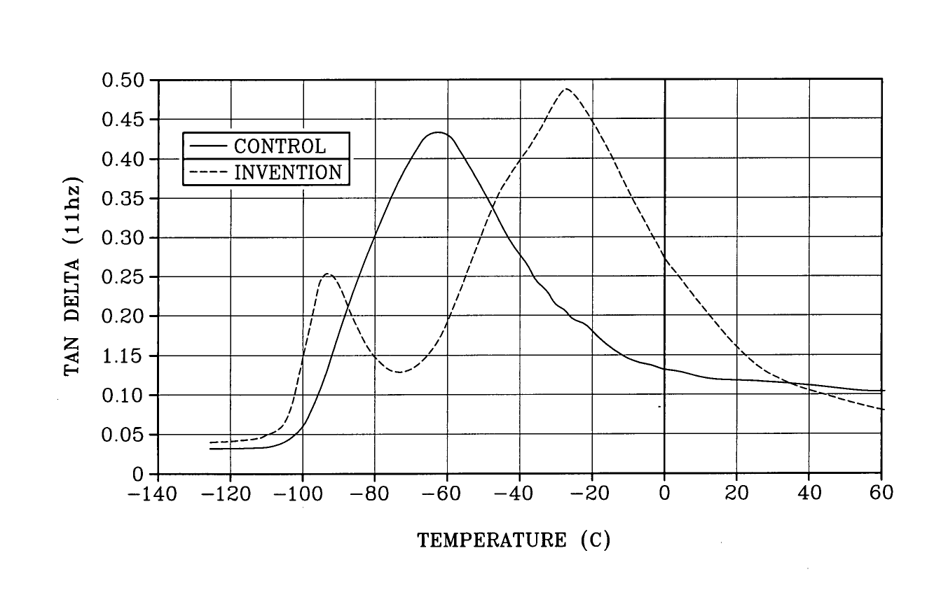

The Applicants hereby incorporate by reference prior U.S. Provisional Application Ser. No. 60/531,083, filed on Dec. 19, 2003.

### FIELD OF THE INVENTION

Pneumatic rubber tire having at least one component of a polybutadiene-rich rubber composition comprised of a blend of a primary, low glass transition temperature (Tg), major continuous phase of cis 1,4-polybutadiene rubber having a degree of branching and a minor, high Tg, dispersed phase of brominated copolymer of isobutylene and paramethylstyrene. Said blend contains reinforcing fillers as a combination of amorphous silica and rubber reinforcing carbon black. Such tire component may be, for example, a circumferential tread having a running surface intended to be ground-contacting.

### BACKGROUND OF THE INVENTION

Pneumatic rubber tires, particularly high performance tires, are normally desired to have treads of a rubber composition which will provide good traction on the road.

An emphasis upon improving a traction characteristic of a tire tread rubber composition often compromises a tire tread's treadwear and/or rolling resistance characteristic as is well known to those having skill in such art.

For example, rubber compositions designed to specifically emphasize improved traction for a tire tread's running surface often present a relatively reduced abrasion resistance physical property and associated relatively greater treadwear property and typically exhibit a relatively high, single, glass transition temperature (Tg) of higher than −50° C. and usually within a range of about 0° C. to about −50° C.

Conversely, rubber compositions designed to specifically emphasize good resistance to abrasion and low rolling resistance for a tire tread often presents relatively reduced tire tread traction and also typically exhibit a single low Tg of lower than −50° C.

Therefore, a tread rubber composition exhibiting a desirable balance between traction and treadwear is difficult to achieve where the rubber composition exhibits only a single glass transition temperature (Tg).

In U.S. Pat. No. 5,723,530, it is mentioned that as tire is desired having a tread where good traction is desired yet still having an acceptable treadwear.

In U.S. Pat. No. 5,723,530, a tire is provided with a tread which is composed of four elastomers, of which two of the elastomers have clearly separated, therefore spatially defined, individual glass transition temperatures (Tg's). In particular the tread rubber composition is comprised of (1) styrenelbutadiene rubber with Tg in a range of −1 5° C. to −45° C.; (2) medium vinyl polybutadiene rubber with vinyl content of 40 to 65 and a Tg in a range of −45° C. to −65° C.; (3) cis 1,4-polybutadiene rubber with a Tg in a range of −95° C. to −105° C.; and (4) cis 1,4-polyisoprene rubber having a Tg in a range of −65° C. to −70° C. The Tg of the cis 1,4-polybutadiene rubber is required to be at least 50° C. lower than the Tg of the styrene/butadiene rubber. A carbon black with required Iodine and DBP (dibutylphthalate) values is also specified. It is readily seen in this patent disclosure that a tire tread rubber composition is provided which exhibits dual Tg's which contains less than 45 phr of cis 1,4-polybutadiene rubber.

Thus, U.S. Pat. No. 5,723,530, while it is directed to a tread rubber composition which exhibits dual Tg's, it is not directed to a tire tread rubber composition which is comprised of a rubber composition which contains greater than 45 phr of cis 1,4-polybutadiene rubber.

U.S. Pat. No. 6,465,560 is directed to a cis 1,4-polybutadiene rich rubber composition for a tire tread rubber containing a minor portion of high styrene containing styrene/butadiene rubber with Tg's sufficiently spaced apart that the two elastomers are, basically, substantially incompatible with each other, as indicated by a plot of Tg versus temperature yields two distinct Tg maximums together with particulate reinforcement as an amorphous silica together with a high structure carbon reinforcement of specified carbon black Iodine value and DBP (dibutylphthalate) value characterization.

In U.S. Pat. No. 5,063,268 there is described a tire tread composed of a brominated copolymer of isobutylene and para methylstyrene, specific diene-based rubbers including polybutadiene rubber, carbon black, plasticizer oil and curing agent. Fillers other than carbon black, such as silica, are mentioned. It is mentioned that the rubber may be present in an amount of from about 25 to about 50 weight percent and the brominated copolymer may be present in an amount of from about 3 to 30 weight percent, the carbon black in an amount of from 20 to about 50 percent, the plasticizer oil in an amount of from above zero to about 25 weight percent, other fillers and additives in an amount of from 3 to about 15 weight percent and curing agent in an amount of from about 1.5 to about 6 weight percent, all of the percentages being based upon the weight of the total composition.

In the description of this invention, terms such as “compounded rubber”, “rubber compound” and “compound”, if used herein, refer to rubber compositions composed of one or more elastomers blended with various ingredients, including curatives such as sulfur and cure accelerators. The terms “elastomer” and “rubber” are used interchangeably unless otherwise indicated. It is believed that all of such terms are well known to those having skill in such art.

A reference to glass transition temperature, or Tg, of an elastomer or elastomer composition, where referred to herein, represents the glass transition temperature(s) of the respective elastomer or elastomer composition in its uncured state or possibly a cured state in a case of an elastomer composition. A Tg can be suitably determined by a differential scanning calorimeter (DSC) at a temperature rate of increase of 10° C. per minute (ASTM D3418-99), a method of determining a Tg of an elastomer which is well known to those having skill in such art.

The existence of more than one glass transition temperature of a cured rubber composition can be determined by dynamic mechanical testing and demonstrated, for example, as a graphical representation, or plot, of tangent delta (tan delta), or of loss modulus (i.e. “E”) as a function of temperature. For the purposes of the description of this invention, the existence of more than one tan delta peak for the rubber composition is evident when at least two tan delta maximums (humps of peaks in the curve), are present in a plot of tan delta versus temperature in a temperature range of from −95° C. to +10° C.

### DISCLOSURE AND PRACTICE OF THE INVENTION

In accordance with this invention, a pneumatic rubber tire is provided having a circumferential rubber tread where said tread is a rubber composition comprised of a blend of, based on parts by weight per 100 parts by weight (phr),
(A) elastomers comprised of
   (1) from 55 to about 85 phr of cis 1,4-polybutadiene rubber having a Tg within a range of about −95° C. to about −105° C., and
   (2) about 15 to about 45 phr of a brominated isobutylene copolymer elastomer as a brominated copolymer of isobutylene and para methylstyrene having a Tg within a range of from about −30° C. to about −60° C.;
   wherein the Tg of said cis 1,4-polybutadiene elastomer is at least 40° C. lower than the Tg of said brominated copolymer of isobutylene and para methylstyrene; and
(B) about 45 to about 100, alternatively about 60 to about 90, phr of reinforcing filler comprised of
   (1) about 5 to about 95, alternately about 5 to about 85, phr of amorphous, precipitated silica, and
   (2) about 5 to about 95, alternately about 5 to about 85, phr of high structure rubber reinforcing carbon black characterized by having an Iodine value (ASTM D1510) in a range of about 116 to about 135, g/kg together with a DBP (dibutylphthalate) value (ASTM D2414) in a range of about 125 to about 140, cm³/100 g; and
(C) a coupling agent having a moiety (e.g.: a silane moiety) reactive with hydroxyl groups (e.g.: silanol groups) contained on the surface of said silica and another moiety interactive with at least one of said elastomers;
wherein said coupling agent is preferably a bis (trialkoxysilylalkyl) polysulfide which contains an average of from 2 to 4 connecting sulfur atoms in its polysulfidic bridge.

In practice, said rubber composition may additionally and optionally contain from about zero to about 10, alternately from about 5 to about 10, phr of cis 1,4-polyisoprene rubber which may be used to improve processing of the rubber composition and may also improve tear resistance of the rubber composition. Preferably the rubber composition does not contain any significant amount of (e.g. less than about 5 phr) any additional elastomers other than said optional cis 1,4-polyisoprene rubber.

In one aspect of the invention, the carbon black and precipitated silica are blended with said cis 1,4-polybutadiene rubber and brominated isobutylene copolymer elastomer in the absence of a combination of sulfur and sulfur vulcanization accelerators by a process which comprises:
(A) blending said carbon black and precipitated silica with a combination of said cis 1,4-polybutadiene rubber and brominated isobutylene copolymer;
(B) blending said carbon black with said cis 1,4-polybutadiene rubber and said precipitated silica with said brominated isobutylene copolymer rubber followed by blending the resulting two rubber compositions together;
(C) blending said precipitated silica with said cis 1,4-polybutadiene rubber and said carbon black with said brominated isobutylene copolymer rubber followed by blending the resulting two rubber compositions together; or
(D) blending said carbon black and said precipitated silica with said cis 1,4-polybutadiene rubber followed by blending said brominated isobutylene copolymer elastomer therewith.

A significant aspect of this invention is the rubber composition composed of a major, continuous phase of the cis 1,4-polybutadiene rubber and a minor, dispersed phase of the copolymer of isobutylene and para methylstyrene in which their spatially defined Tg's are spaced apart by at least 40° C. in a manner that said minor phase of said copolymer of isobutylene and para methylstyrene is basically immiscible in said cis 1,4-polybutadiene rubber.

Another aspect of the invention is that such rubber composition of said cis 1,4-polybutadiene rubber and said brominated copolymer of isobutylene and para methylstyrene has two tan delta maximums within a temperature range of from −95° C. to +10° C.

The Tg's of said rubber composition can be determined by differential scanning calorimetry (DSC), as hereinbefore discussed, which is a method well known to those having skill in such analytical art. The aspect that the rubber composition has two tan delta maximums within a temperature range of from −95° C. to +10° C. can be readily be determined by dynamic physical testing with an RSAII sample analysis instrument from the Rheometrics Scientific Company which plots a tan delta curve from a rubber sample.

The continuous phase of the major cis 1,4-polybutadiene rubber and minor discontinuous phase of the relatively immiscible brominated copolymer of isobutylene and para methylstyrene are seen as being incompatible with each other as illustrated in a plot of the rubber composition's tan delta versus temperature (see the accompanying Drawing) which exhibits two distinct tan delta maximums within a temperature range of from −95° C. to +10° C.

This is considered herein to be significant because the relatively incompatible two-phases of the rubber composition helps to maximize performance of the rubber composition. In particular, it is considered that the relatively continuous major cis 1,4-polybutadiene rubber phase maximizes the wear resistance (abrasion resistance) as well as rolling resistance and winter (snow) traction for a tire tread of such rubber composition, and the relatively discontinuous minor dispersed phase of said brominated copolymer of isobutylene and para methylstyrene tends to maximize wet traction for a tire tread of such rubber composition.

A further significant aspect of the invention is the inclusion of an amorphous silica, preferably a precipitated silica, together with a silica coupler to aid in coupling the silica the diene-based elastomers and said copolymer of isobutylene and para methylstyrene.

This is considered herein to be significant because the coupling agent enhances the interaction of the silica and copolymer of isobutylene and para methylstyrene with the diene-based elastomer(s) to provide greater reinforcement and strength of the rubber composition and to promote a lower hysteresis of the rubber composition which is considered herein to be beneficial to improve tire tread durability and to improve fuel efficiency of an associated vehicle.

Representative of such coupling agents are for example, a bis(3-triethoxysilylpropyl) polysulfide having an average of from about 2 to about 4 connecting sulfur atoms in its polysulfidic bridge. If desired, such coupling agent may have a significantly more limitive polysulfide moiety in the nature of an average of only from about 2 to about 2.6 connecting sulfur atoms in its polysulfide bridge or, in the alternative, a more liberal average of from about 3.4 to about 3.8 connecting sulfur atoms in its polysulfidic bridge.

In practice, the rubber composition may be prepared by a process which comprises blending a bis(3-triethoxysilylpropyl) polysulfide having an average of from about 2 to about 2.6 connecting sulfur atoms in its polysulfidic bridge with the said cis 1,4-polybutadiene rubber and brominated isobutylene copolymer elastomer in the absence of a combination of free sulfur and sulfur vulcanization accelerator(s) (in one or more sequential productive mixing stages at a temperature of, for example, in a range of from about 140° C. to about 180° C.) followed by, in a subsequent mixing step (a productive mixing stage at a temperature of, for example, in a range of from about 90° C. to about 120° C.), blending a bis(3-triethoxysilylpropyl) polysulfide having an average of from about 3.4 to about 3.8 connecting sulfur atoms in its polysulfidic bridge therewith together with free sulfur and vulcanization accelerator(s). Such sequential non-productive and productive mixing stages, particularly in internal rubber mixers, which cooling the rubber mixture to a temperature below 40° C. between mixing steps, is well known to those having skill in such art.

Alternatively, such coupling agent may be an organophosphite, which may optionally be used in combination with said bis(3-triethoxysilylpropyl) polysulfide having an average of from about 2 to about 4 connecting sulfur atoms in its polysulfidic bridge, to aid in the reinforcement of the brominated copolymer of isobutylene and paramethylstyrene selected from organodiphosphites and organomonophosphites. For example of use of such organophosphites to aid in coupling a silica, such as for example a precipitated silica, to a brominated copolymer of isobutylene and paramethylstyrene, see U.S. Pat. No. 6,525,128.

Representative of such organophosphites are, for example, triisodecyl phosphite, trilauryl phosphite, tris(tridecyl) phosphite, diphenyl isooctyl phosphite, diphenyl isodecyl phosphite, phenyl diisodecyl phosphite, triphenyl phosphite and triisononylphenyl phosphite, tris (2,4-dit-butylphenyl) phosphite, distearyl pentaerythritol diphosphite, bis (2,4-di-t-butylphenyl) pentaerythritol diphosphite, bis (2,6,di-t-butyl-4-methylphenyl pentaerythritol diphosphite, bis (2,4-dicumylphenyl)pentaerythritol diphosphite and bis 2,4,6,tri-t-butylphenyl 2-butyl-2-ethyl-1,3-propanediol phosphite, trimethyl phosphite, triethyl phosphite, tris (2-chloroethyl) phosphite, triisopropyl phosphite, tributyl phosphite, triisooctyl phosphite and tris (2-ethylhexyl)phosphite and mixtures thereof. Preferably, such organophosphites are selected from tris(2-ethylhexyl)phosphite and triphenyl phosphite.

It is to be appreciated that the combination of cis 1,4-polybutadiene rubber and the copolymer of isobutylene and para methystyrene are in the clear majority insofar as elastomers in the tread rubber are concerned and, moreover, that the Tg of the cis 1,4-polybutadiene rubber is at least 40° C. lower than the Tg of the copolymer of isobutylene and para methylstyrene and at least 30° C. lower than said additional diene-based elastomers.

It is to be further appreciated that at least 55 phr of the rubber composition is of the cis 1,4-polybutadiene rubber and it is desired that at least 15 weight percent of the said additional elastomers have a Tg of at least 40° C. higher than the Tg of the cis 1,4-polybutadiene.

As hereinbefore discussed, in this manner it is considered herein that the relatively low Tg cis 1,4-polybutadiene elastomer is relatively incompatible with the high Tg copolymer of isobutylene and para methylstyrene as evidenced by dual tan delta peaks on a graphical presentation, or plot, of tan delta versus temperature of the cured rubber composition for a temperature range of from −95° C. to +10° C.

Accordingly, as hereinbefore discussed, it is considered herein that these elastomers of said tread rubber are present in two phases, comprised of the cis 1,4 polybutadiene major phase, considered herein to be the continuous phase and the minor dispersed phase of the copolymer of isobutylene and para methylstyrene.

In particular, a graphical plot of tan delta versus temperature curve over a broad range of −120° C. to +80° C. (inclusive of the aforesaid temperature range of from −95° C. to +10° C.) for the rubber composition of this invention presents two peaks in the curve with a first peak having its apex within a relatively low temperature range of −100° C. to −80° C. and a second broad-based peak with its apex within a higher temperature range of −30° C. to −10° C.

Evidence of the elastomer incompatibilities is the presence of the dual tan delta peaks for the sulfur cured elastomer composition for the composition of this invention.

The presence of the two tan delta peaks within the aforesaid temperature range, as a result of the aforesaid immiscibility of the elastomers, is also significant because, for the cured compounded rubber, it is considered herein that a combination of the tan delta peak, at the lower temperature (−100° C. to −80° C.) for the low Tg elastomer (the cis 1,4-polybutadiene), is indicative of promotion of improved resistance to abrasion (resistance to tread wear) as well as reduced rolling resistance and increased winter (snow) traction for a tire with a tread of such composition together with the second broad tan delta peak, at the higher temperature (−30° C. to −10° C.) represented by the high Tg elastomer (the brominated copolymer of isobutylene and para methylstyrene), is indicative of promotion of higher hysteresis at temperatures within a range of about −30 to about +10° C. (predictive of higher tire tread wet traction), all of which is predictive of a better balance of such abrasion resistance and traction properties, particularly for a tire tread, than a cured rubber composition exhibiting only a single tan delta peak within a temperature range of −95° C. to +10° C.

In practice, the brominated copolymer of isobutylene and para methylstyrene may be obtained as a post brominated copolymer of isobutylene and para methylstyrene. In practice, the para methylstyrene may be an alkylstyrene mixture of alkyl substituted styrenes where the alkyl substituted may have from 1 to 11 carbon atoms and is composed of at least 90 and preferably at least 95 percent units derived from para methylstyrene so that it is simply referred to herein as “para methylstyrene”. In practice, preferably the copolymer is composed of from about 85 to about 99 weight percent units derived from isobutylene and, correspondingly from about 1 to about 15 percent units derived from the para methylstyrene.

Desirably, the copolymer is post halogenated with a resulting bromine content of up to about 5 weight percent, alternately about 0.2 to about 1.5 or even up to 2.5 weight percent bromine.

A representative brominated copolymer of isobutylene and paramethylstyrene is EXXPRO from ExxonMobil Company. Such brominated copolymer is understood to have, for example, a Mooney viscosity ML(1+8) at 123° C. of about 50, an isobutylene content of about 94 to 95 weight percent and a para methylstyrene content of about 5 weight percent, with a total bromine content of about 0.8 weight percent. A reference may be made to European patent publications EP 0344021 and EP 0801105.

In the practice of this invention, the aforesaid use of a quantitative amount of at least 55 phr of the high cis 1,4-polybutadiene elastomer in the rubber composition of this invention is considered herein to be important in order to enhance resistance to abrasion for the tire tread.

Use of an optional additional elastomer such as the cis 1,4-polyisoprene, preferably natural cis 1,4-polyisoprene rubber, is considered herein to be important in order to improve processability of the uncured tire tread rubber composition and tear resistance of the cured rubber composition.

The addition of the cis 1,4-polyisoprene natural rubber is also considered herein to be important to contribute to tear resistance property for the tread rubber composition.

As hereinbefore discussed, use of rubber reinforcing carbon black(s) for this invention, with the characterized Iodine adsorption value range and DBP number range, is considered herein to be important in order to provide good abrasion resistance, or coefficient of friction, and higher stiffniess for the tire cornering and handling, and also enhanced, or relatively high hysteresis for relatively good traction for a tire tread.

Representative of such rubber reinforcing carbon blacks are, for example, N121 and N205 as ASTM designated carbon backs. Such representative carbon blacks, including N121 and N205 carbon blacks, have an Iodine adsorption number within a range of about 110 to about 145 g/kg and a DBP number in a range of about 110 to about 140 cm³/g. Examples of reinforcing carbon blacks for elastomers, generally, together with their Iodine number values and DBP (dibutyl phthalate) absorption values, may be found in The Vanderbilt Rubber Handbook, (1990), 13th edition, Pages 416 through 419.

In the practice of this invention, use of the specific combinations of the aforesaid silica-rich, multiphase elastomer blend and coupling agent together with the exfoliated clay platelets are considered herein to be important in order to optimize resistance to abrasion (treadwear) and to provide a suitable hysteresis (i.e. traction).

As hereinbefore pointed out, the invention is based upon use of individual elastomers and brominated copolymer of isobutylene and para methylstyrene, silica and coupling agent, most of which of which are usually known, in what is considered herein as a novel combination as to
(A) selection of specific individual materials, and
(B) combining the selected specific materials in novel combinations in terms of individual amounts in a manner not believed to be specifically heretofore used for a tire tread.

This aspect of the invention is considered particularly important for creating a tire tread rubber composition with good abrasion properties coupled, also, with good traction, or coefficient of friction, or hysteresis, properties.

In practice, the commonly employed amorphous silica is used is usually a precipitated silica, although the silica may be a pyrogenic silica, all which are well known to those having skill in such art.

The precipitated silicas are in a form of aggregates thereof which may be obtained, for example, by the acidification of a soluble silicate, e.g., sodium silicate or a co-precipitation of a silicate and an aluminate with an inclusion of a suitable electrolyte to promote formation of silica aggregates.

The BET surface area of the silica, as measured using nitrogen gas, may, for example, be in a range of about 50 to about 300, alternatively about 120 to about 200, square meters per gram. A BET method of measuring surface area is described in the Journal of the American Chemical Society, Volume 60, Page 304 (1930).

The silica may also have a dibutylphthalate (DBP) absorption value in a range of about 100 to about 400, and usually about 150 to about 300 cm³/100 g.

Various commercially available silicas may be considered for use in this invention such as, for example, only and without limitation, silicas commercially available from PPG Industries under the Hi-Sil trademark with designations 210, 243, etc; silicas available from Rhodia, with such as for example of Zeosil 1165MP™ and ZeosiII65GRTM and silicas available from Degussa AG with designations VN2™ and VN3™, 3770GR™ and from Huber such as for example Zeopol 8745™.

As hereinbefore discussed, the silica reinforcement is conventionally used with a coupling agent which aids in coupling the silica to the cis 1,4-polybutadiene and brominated copolymer of isobutylene and para methylstyrene.

Such coupling agents, for example, may be premixed, or pre-reacted, with the silica particles or added to the rubber mix during a rubber/silica processing, or mixing, stage. If the coupling agent is added to the rubber mixture during a rubber mixing stage separately from the and silica and brominated copolymer of isobutylene and para methylstyrene, it is considered that the coupling agent then combines in situ within the rubber host with the silica and brominated copolymer of isobutylene and para methylstyrene.

Numerous coupling agents may be used, including usually those taught for use in combining silica and rubber such as, for example and as hereinbefore discussed, silane coupling agents containing a polysulfide component, or structure, such as bis-(3-alkoxysilylalky) polysulfide which contains primarily 2 to 6 sulfur atoms in its polysulfidic bridge with an average of from 2 to 4, alternately an average of from 2 to 2.6 or an average of from 3.4 to about 3.8 connecting sulfur atoms in its polysulfidic bridge such as, for example, a bis-(3-triethoxysilylpropyl) polysulfide.

It is readily understood by those having skill in the art that the rubber compositions of the tread would be compounded with conventional compounding ingredients including the aforesaid reinforcing fillers such as carbon black and precipitated silica, as hereinbefore defined, in combination with a silica coupling agent, as well as antidegradant(s), processing oil as hereinbefore defined, stearic acid or a zinc stearate, zinc oxide, sulfur-contributing material(s) and vulcanization accelerator(s) as hereinbefore defined.

Such compounding of rubber is well known to those having skill in such art. Antidegradants are typically of the amine or phenolic type. While stearic acid is typically referred to as a rubber compounding ingredient, it may be pointed out that the ingredient itself is usually obtained and used as a mixture of organic acids primarily composed of stearic acid with at least one of oleic acid, linolenic acid and/or palmitic acid normally contained in the stearic acid as typically used. The mixture may contain minor amounts (less than about six weight percent) of myristic acid, arachidic acid and/or arachidonic acid. Such material or mixture is conventionally referred to in the rubber compounding art as stearic acid.

Where normal or typical rubber compounding amounts or ranges of amounts of such additives are used, they are not otherwise considered as a part of the invention. For example, some of the ingredients might be classified, in one aspect, as processing aids. Such processing aids may be, for example, waxes such as microcrystalline and paraffinic waxes typically used in a range of about 1 to 5 phr and often in a range of about 1 to about 3 phr; and resins, usually as tackifiers, such as, for example, synthetic hydrocarbon and natural resins typically used in a range of about 1 to 5 phr and often in a range of about 1 to about 3 phr. A curative might be classified as a combination of sulfur and sulfur cure accelerator(s) for the rubber compound (usually simply referred to as accelerator) or a sulfur donor/accelerator. In a sulfur and accelerator(s) curative, the amount of sulfur used is in a range of about 0.5 to about 5 phr and usually in a range of about 0.5 to about 3 phr; and the accelerator(s), often of the sulfenamide type, is (are) used in a range of about 0.5 to about 5 phr and often in a range of about 1 to about 2 phr. The ingredients, including the elastomers but exclusive of sulfur and accelerator curatives, are normally first mixed together in a series of at least two sequential mixing stages, although sometimes one mixing stage might be used, to a temperature in a range of about 145° C. to about 185° C., and such mixing stages are typically referred to as non-productive mixing stages. Thereafter, the sulfur and accelerators, and possibly one or more retarders and one or more antidegradants, are mixed therewith to a temperature of about 90° C. to about 120° C. and is typically referred as a productive mix stage. Such mixing procedure is well known to those having skill in such art.

After mixing, the compounded rubber can be fabricated such as, for example, by extrusion through a suitable die to form a tire tread. The tire tread is then typically built onto a sulfur curable tire carcass and the assembly thereof cured in a suitable mold under conditions of elevated temperature and pressure by methods well-known to those having skill in such art. In such case of retreading of a tire, the tire tread might first be precured and then applied to the already cured tire carcass with a curable gum strip between the tread and carcass and the assembly then submitted to curing conditions to cure the aforesaid gum strip.

The invention may be better understood by reference to the following example in which the parts and percentages are by weight unless otherwise indicated.

### EXAMPLE I

Rubber compositions were prepared and identified herein as Control Sample A, Control Sample B and Sample C.

All of the Samples contained a combination of carbon black and precipitated silica, with coupling agent, reinforcement.

Control Sample A contained natural rubber, organic solvent solution polymerization prepared styrene/butadiene rubber (S-SBR-1), 3,4-polyisoprene rubber and natural rubber.

Control Sample B contained a branched cis 1,4-polybutadiene rubber and organic solvent solution polymerization prepared styrene/butadiene rubber (S-SBR-2).

Sample C contained the branched cis 1,4-polybutadiene rubber and brominated copolymer of isobutylene and paramethylstyrene.

The Samples were prepared by mixing the ingredients, other than the sulfur and accelerator curatives, in a first non-productive mixing step in an internal rubber mixer to a temperature of about 170° C. Then the rubber mixture was mixed in a second non-productive mixing step in an internal rubber mixer to a temperature of about 145° C. in which silica and coupling agent were added. After each of the non-productive mixing steps, the rubber mixture was dumped from the mixer, open roll milled, sheeted out and allowed to cool to a temperature below 40° C. The rubber mixture was then mixed in a productive mixing step to a temperature of about 115° C. in which sulfur and accelerators were added

TABLE 1

| | Control | Control | |
|---|---|---|---|
| Material | Sample A | Sample B | Sample C |
| First Non-Productive Mixing | | | |
| Natural rubber¹ | 55 | 0 | 0 |
| S-SBR-1 elastomer² | 30 | 0 | 0 |
| 3,4-polyisoprene³ | 15 | 0 | 0 |
| Cis 1,4-polybutadiene⁴ | 0 | 70 | 70 |
| Brominated isobutylene para | 0 | 0 | 30 |
| methylstyrene copolymer⁵ | | | |
| S-SBR-2 elastomer⁶ | 0 | 30 | 0 |
| Carbon black⁷ | 38 | 38 | 38 |
| Processing oils and waxes | 8 | 8 | 8 |
| Stearic acid | 2 | 2 | 2 |
| Zinc oxide | 2.5 | 2.5 | 2.5 |
| Antidegradants | 3 | 3 | 3 |
| Second Non-Productive Mixing | | | |
| Silica⁸ | 10 | 10 | 10 |
| Silica coupling agent⁹ | 2 | 2 | 2 |
| Productive mixing | | | |
| Sulfur | 1.5 | 1.5 | 1.5 |
| Accelerator(s)¹⁰ | 1.1 | 1.1 | 1.1 |

¹Cis 1,4-polyisoprene natural rubber
²Solvent solution polymerization prepared styrene/butadiene copolymer rubber containing about 12 weight percent bound styrene as Solflex ® 1216 from The Goodyear Tire & Rubber Company
³A 3,4-polyisoprene rubber having a Tg of about −16° C. from The Goodyear Tire & Rubber Company
⁴Cis 1,4-polybutadiene elastomer, reported above on a dry weight basis, having a high cis 1,4- content of at least 95 percent and having and a Tg of about −100° C. obtained as Budene ® 1280 from The Goodyear Tire & Rubber Company
⁵Brominated copolymer of isobutylene and para methylstyrene as EXXPRO ™ from the ExxonMobil Company
⁶Solvent solution polymerization prepared styrene/butadiene copolymer rubber containing about 25 weight percent bound styrene and a vinyl (1,2-butadiene) content of about 52 percent as Solflex ® 2552 from The Goodyear Tire & Rubber Company
⁷Carbon black N299, an ASTM designation
⁸Precipitated silica as HiSil 210 from PPG Industries
⁹A composite of a 50/50 weight ratio of carbon black and bis-(3-triethoxysilylpropyl) polysulfide having an average connecting sulfur atoms in its polysulfidic understood to be with a range of about 3.5 to about 4 as X505 ™ from the Degussa Company and reported in Table 1 as the composite
¹⁰Accelerators as sulfenamide and thiuram types

The prepared Samples various physical properties of the Samples are shown in the following Table 2.

TABLE 2

| | Control | Control | |
|---|---|---|---|
| Property | Sample A | Sample B | Sample C |
| Cold rebound, zwick, (%) at 0° C. | 26 | 46 | 24 |
| Room temp rebound, zwick (%) at | 62 | 52 | 37 |
| 23° C. | | | |
| Hot rebound, zwick (%) at 100° C. | 70 | 63 | 69 |
| Delta rebound (hot room temp | 44 | 17 | 45 |
| rebound) | | | |
| DIN abrasion loss, 10 N, relative¹ | 131 | 59 | 60 |
| Shore A hardness (23° C.) | 62 | 63 | 69 |
| Shore A hardness (100° C.) | 54 | 57 | 63 |
| Brittle point (° C.)² | −50 | −64 (limit) | −64 (limit) |

¹DIN abrasion data (DIN No. 53516 at 10 Newtons) for the Samples is reported in the above Table 2 as relative volume loss, namely relative to a control, a representation well known to those having skill in such art. The lower the value the better the predicted tread wear performance (better performance is lower treadwear).
²The brittle point is determined by ASTM D-746. A limit of −64° C. was placed on the analysis so that, for Control Sample B and Sample C, their brittle points were beyond the limit of the analysis.

It can be seen from Table 2 that Sample C has the lowest rebound at both 0° C. and 23° C. which is indicative of the best tire tread traction, or grip for a tire having a tread of such rubber composition. Sample C has a very high hot (100° C.) rebound which is indicative of good tire low rolling resistance for a tire with a tread of such rubber composition. Further, Sample C had the highest delta rebound (100° C. rebound minus room temperature rebound values) which is indicative of a superior balance of wet traction and low rolling resistance for a tire having a tread of such rubber composition.

It was unexpectedly observed that Sample C demonstrated excellent abrasion resistance because rubber compositions which exhibit good traction of low Rebound values at 0° C. and 23° C. had a very low brittle point (for a tire having a tread of such rubber composition). This is especially surprising since the Sample C rubber composition had two Tg's, one of which appeared as a relatively high temperature, namely a peak at about −30° C.

Such novel balance of such physical properties of the rubber compositions is attributed to the phases of the elastomers (the cis 1,4-polybutadiene and the brominated isobutylene copolymer) being immiscible with each other and the fact that the low Tg elastomer (the cis 1,4-polybutylene rubber) is the continuous and major phase of the rubber composition.

In particular, although the higher Tg polymer (the brominated isobutylene copolymer) is the minor phase of the rubber composition, namely only 30 weight percent of the elastomers, due to the fact that it is immiscible with the major phase of the low Tg elastomer, it is able to largely retain a significant component of its individual physical property(ies) and thereby provide a benefit for the rubber composition in a form of the aforesaid wet traction enhancement without such property being significantly masked by the overall rubber composition.

On the other hand, the major, continuous phase low Tg elastomer (the cis 1,4-polybutadiene, because of its immiscibility with the high Tg polymer, is able to largely retain its retain a significant component of its individual physical property(ies) and thereby provide a benefit for the rubber composition in a form of the aforesaid excellent abrasion resistance, brittle point enhancement and low rolling resistance potential without such properties being significantly masked by the overall rubber composition.

It is considered herein that such balance of physical properties is novel, a departure from past practice and unexpected.

Control Sample B and Sample C representing the invention were tested using a RSAII sample analysis machine from Rheometrics Scientific Company. The Samples were tested using a temperature sweep at 11 Hertz (Hz) and a 0.1 percent dynamic strain. The results in terms of tan delta versus Temperature at 11 Hz are demonstrated in the accompanying Drawing.

In particular, the Drawing is presented as a graph representing a plot of tan delta versus temperature for the Sample B (the Control) and Sample C (the Invention).

In the Drawing, it can readily be seen that the curve for Sample B displays a single tan delta peak in the region from −100° C. to +10° C., while the tan delta curve for Sample C displays dual tan delta peaks which are spaced apart by at least 40° C., with the first peak being representative of the cis 1,4-polybutadiene rubber within a lower temperature range of from about −100° C. to about −80° C. and the second tan delta peak within a higher temperature range of from about −30° C. to about +10° C. being representative of the brominated copolymer of isobutylene and paramethylstyrene polymer.

Therefore, it is considered herein to be important that the tan delta curves of the Drawing confirm the hereinbefore presented observation that, for the cured compounded rubber Sample C, a combination of the tan delta peak, at the lower temperature range (−100° C. to −80° C.) for the low Tg elastomer (e.g. cis 1,4-polybutadiene), is indicative of promotion of improved resistance to abrasion (resistance to tread wear) as well as reduced rolling resistance and increased winter (snow) traction for a tire with a tread of such composition together with the second tan delta peak, at the higher temperature range (−30° C. to +10° C.) represented by the high Tg elastomer (e.g. the brominated copolymer of isobutylene and para methylstyrene), is indicative of promotion of higher hysteresis at temperatures within a range of about −30 to about +10° C. (e.g.. higher tire tread wet traction), all of which is predictive of a better balance of such abrasion resistance and traction properties, particularly for a tire tread, than a cured rubber composition (Control Sample B) exhibiting only a single tan delta peak within a temperature range of −90° C. to +10° C.

While certain representative embodiments and details have been shown for the purpose of illustrating the invention, it will be apparent to those skilled in this art that various changes and modifications may be made therein without departing from the spirit or scope of the invention.

1. A pneumatic rubber tire having a circumferential rubber tread where said tread is a rubber composition comprised of a blend of, based on parts by weight per 100 parts by weight (phr),
(A) elastomers comprised of
(1) from 45 to about 85 phr of cis 1,4-polybutadiene rubber having a Tg within a range of about −95° C. to about −105° C., and
(2) about 15 to about 45 phr of a brominated isobutylene copolymer elastomer as a brominated copolymer of isobutylene and para methylstyrene having a Tg within a range of from about −30° C. to about −60° C.;
wherein the Tg of said cis 1,4-polybutadiene elastomer is at least 40° C. lower than the Tg of said brominated copolymer of isobutylene and para methylstyrene and at least 30° C. lower than the Tg of said additional diene-based elastomer(s); and
(B) about 45 to about 100 phr of reinforcing filler comprised of
(1) about 5 to about 95 phr of amorphous, precipitated silica, and
(2) about 5 to about 95 phr of high structure rubber reinforcing carbon black characterized by having an Iodine value in a range of about 116 to about 135, g/kg together with a DBP value in a range of about 125 to about 140, cm³/100 g; and
(C) a coupling agent having a moiety reactive with hydroxyl groups contained on the surface of said silica and another moiety interactive with at least one of said elastomers.

2. The tire of claim 1 wherein said rubber composition contains from about 5 to about 10 phr of cis 1,4-polyisoprene rubber.

3. The tire of claim 1 wherein, for said tread rubber composition, said carbon black and precipitated silica are blended with said cis 1,4-polybutadiene rubber and brominated isobutylene copolymer elastomer in the absence of a combination of sulfur and sulfur vulcanization accelerators by a process which comprises:
(A) blending said carbon black and precipitated silica with a combination of said cis 1,4-polybutadiene rubber and brominated isobutylene copolymer;
(B) blending said carbon black with said cis 1,4-polybutadiene rubber and said precipitated silica with said brominated isobutylene copolymer rubber followed by blending the resulting two rubber compositions together;
(C) blending said precipitated silica with said cis 1,4-polybutadiene rubber and said carbon black with said brominated isobutylene copolymer rubber followed by blending the resulting two rubber compositions together; or
(D) blending said carbon black and said precipitated silica with said cis 1,4-polybutadiene rubber followed by blending said brominated isobutylene copolymer elastomer therewith.

4. The tire of claim 1 wherein said carbon black and precipitated silica are blended with said cis 1,4-polybutadiene rubber and brominated isobutylene copolymer elastomer in the absence of a combination of sulfur and sulfur vulcanization accelerators by a process which comprises blending said carbon black and precipitated silica with a combination of said cis 1,4-polybutadiene rubber and brominated isobutylene copolymer.

5. The tire of claim 1 wherein said carbon black and precipitated silica are blended with said cis 1,4-polybutadiene rubber and brominated isobutylene copolymer elastomer in the absence of a combination of sulfiir and sulfur vulcanization accelerators by a process which comprises blending said carbon black with said cis 1,4-polybutadiene rubber and said precipitated silica with said brominated isobutylene copolymer rubber followed by blending the resulting two rubber compositions together.

6. The tire of claim 1 wherein said carbon black and precipitated silica are blended with said cis 1,4-polybutadiene rubber and brominated isobutylene copolymer elastomer in the absence of a combination of sulfur and sulfur vulcanization accelerators by a process which comprises blending said precipitated silica with said cis 1,4-polybutadiene rubber and said carbon black with said brominated isobutylene copolymer rubber followed by blending the resulting two rubber compositions together.

7. The tire of claim 1 wherein said carbon black and precipitated silica are blended with said cis 1,4-polybutadiene rubber and brominated isobutylene copolymer elastomer in the absence of a combination of sulfur and sulfur vulcanization accelerators by a process which comprises blending said carbon black and said brominated isobutylene copolymer with said cis 1,4-polybutadiene rubber followed by blending said brominated isobutylene copolymer rubber therewith.

8. The tire of claim 1 wherein, for said tread rubber composition, said coupling agent is a bis(3-ethoxysilylproplyl) polysulfide having an average of from 2 to 4 connecting sulfur atoms in its polysulfidic bridge.

9. The tire of claim 3 wherein, for said tread rubber composition, said coupling agent is a bis(3-ethoxysilylproplyl) polysulfide having an average of from 2 to 4 connecting sulfur atoms in its polysulfidic bridge.

10. The tire of claimlwherein, for said tread rubber composition, said coupling agent is a bis(3-ethoxysilylproplyl) polysulfide having an average of from 2 to about 2.6 connecting sulfur atoms in its polysulfidic bridge.

11. The tire of claim 3 wherein, for said tread rubber composition, said coupling agent is a bis(3-ethoxysilylproplyl) polysulfide having an average of from 2 to about 2.6 connecting sulfur atoms in its polysulfidic bridge.

12. The tire of claimlwherein, for said tread rubber composition, said coupling agent is a bis(3-ethoxysilylproplyl) polysulfide having an average of from about 3.4 to about 3.8 connecting sulfur atoms in its polysulfidic bridge.

13. The tire of claim 3 wherein, for said tread rubber composition, said coupling agent is a bis(3-ethoxysilylproplyl) polysulfide having an average of from about 3.4 to about 3.8 connecting sulfur atoms in its polysulfidic bridge.

14. The tire of claim 1 wherein said tread rubber composition is prepared by a process which comprises blending a bis(3-triethoxysilylpropyl) polysulfide having an average of from about 2 to about 2.6 connecting sulfur atoms in its polysulfidic bridge with said cis 1,4-polybutadiene rubber and said brominated isobutylene copolymer elastomer in the absence of a combination of free sulfur and sulfur vulcanization accelerators followed by, in a subsequent mixing step, blending a bis(3-triethoxysilylpropyl) polysulfide having an average of from about 3.4 to about 3.8 connecting sulfur atoms in its polysulfidic bridge together with free sulfur and sulfur vulcanization accelerator(s).

15. The tire of claim 3 wherein said tread rubber composition is prepared by a process which comprises blending a bis(3-triethoxysilylpropyl) polysulfide having an average of from about 2 to about 2.6 connecting sulfur atoms in its polysulfidic bridge with said cis 1,4-polybutadiene rubber and said brominated isobutylene copolymer elastomer in the absence of a combination of free sulfur and sulfur vulcanization accelerators followed by, in a subsequent mixing step, blending a bis(3-triethoxysilylpropyl) polysulfide having an average of from about 3.4 to about 3.8 connecting sulfur atoms in its polysulfidic bridge together with free sulfur and sulfur vulcanization accelerator(s).

16. The tire of claim 1 wherein, for said tread rubber composition, said coupling agent is an organophosphite selected from at least one of triisodecyl phosphite, trilauryl phosphite, tris(tridecyl) phosphite, diphenyl isooctyl phosphite, diphenyl isodecyl phosphite, phenyl diisodecyl phosphite, triphenyl phosphite and triisononylphenyl phosphite, tris (2,4-dit-butylphenyl) phosphite, distearyl pentaerythritol diphosphite, bis (2,4-di-t-butylphenyl) pentaerythritol diphosphite, bis (2,6,di-t-butyl-4-methylphenyl pentaerythritol diphosphite, bis (2,4-dicumylphenyl)pentaerythritol diphosphite and bis 2,4,6,tri-t-butylphenyl 2-butyl-2-ethyl-1,3-propanediol phosphite, trimethyl phosphite, triethyl phosphite, tris (2-chloroethyl) phosphite, triisopropyl phosphite, tributyl phosphite, triisooctyl phosphite and tris (2-ethylhexyl)phosphite and mixtures thereof.

17. The tire of claim 1 wherein, for said tread rubber composition, said coupling agent is an organophosphite selected from tris(2-ethylhexyl)phosphite and triphenyl phosphite.

18. The tire of claim 3 wherein, for said tread rubber composition, said coupling agent is an organophosphite selected from at least one of triisodecyl phosphite, trilauryl phosphite, tris(tridecyl) phosphite, diphenyl isooctyl phosphite, diphenyl isodecyl phosphite, phenyl diisodecyl phosphite, triphenyl phosphite and triisononylphenyl phosphite, tris (2,4-dit-butylphenyl) phosphite, distearyl pentaerythritol diphosphite, bis (2,4-di-t-butylphenyl) pentaerythritol diphosphite, bis (2,6,di-t-butyl-4-methylphenyl pentaerythritol diphosphite, bis (2,4-dicumylphenyl)pentaerythritol diphosphite and bis 2,4,6,tri-t-butylphenyl 2-butyl-2-ethyl-1,3-propanediol phosphite, trimethyl phosphite, triethyl phosphite, tris (2-chloroethyl) phosphite, triisopropyl phosphite, tributyl phosphite, triisooctyl phosphite and tris (2-ethylhexyl)phosphite and mixtures thereof.

19. The tire of claim 3 wherein, for said tread rubber composition, said coupling agent is an organophosphite selected from tris(2-ethylhexyl)phosphite and triphenyl phosphite.

20. The tire of claim 16 wherein said coupling agent is said organophosphite coupling agent in combination with a bis(3-triethoxysilylpropyl) polysulfide coupling agent having an average of from about 2 to about 4 connecting sulfur atoms in its polysulfidic bridge.
